(19) United States
(12) Patent Application Publication
(10) Pub. No.: US 2006/0119709 A1
(43) Pub. Date: Jun. 8, 2006

(54) Digital imaging apparatus and image display method

(75) Inventor: Yasuhiro Morimoto, Yokohama (JP)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/293,985

(22) Filed: Dec. 5, 2005

(30) Foreign Application Priority Data
Dec. 8, 2004 (JP) 2004-355827

(51) Int. Cl. H04N 5/225; H04N 9/04

(52) U.S. Cl. 348/207.99

(57) ABSTRACT

A digital imaging apparatus with a plurality of displays that can display the same content or different content. In a first mode, the same image content may be displayed on both displays, in a second mode, image content may be displayed on one of the displays, and in a third mode, different content may be displayed on the two displays simultaneously. The displays may be of different sizes to accommodate displaying image content in a normal mode or in a wide mode. The viewing angle of two orthogonally disposed displays may be selected so that the displays provide a substantially combined continuous viewing angle greater than 90 degrees.

### CROSS-REFERENCE TO RELATED PATENT APPLICATIONS

This application claims the priority of Japanese Patent Application No. 2004-355827, filed on Dec. 8, 2004, in the Japanese Patent Office, the disclosure of which is incorporated herein in its entirety by reference.

### BACKGROUND OF THE INVENTION

1. Field of the Invention

The present invention relates to a digital imaging apparatus and an image display method, and more particularly, to a digital imaging apparatus that can satisfactorily display different contents on at least two displays and an image display method.

2. Description of the Related Art

Conventional high quality digital still cameras include status liquid crystal displays that display the status, such as an iris, a shutter speed, etc., of the cameras on the top of the camera body. Also, as described in Japanese Patent Laid-Open Publication No. 2004-180022, two displays, a main display disposed on one side of an enclosure part of a mobile phone and another display disposed on the rear side of the enclosure part, are controlled in accordance with an open/close state of the mobile phone.

Conventional digital still cameras display a photographed image on liquid crystal displays for monitors that are arranged on the back of the camera body. A disadvantage of such cameras is that a photographed image cannot be displayed or viewed from the status liquid crystal display on the top of the camera body.

Some conventional digital still cameras include mechanisms for rotating the viewing angle of a liquid crystal display disposed at the back of the camera body. However, such mechanisms result in increased manufacturing cost and introduce the risk of mechanical malfunction.

Relatively thin digital still cameras have a top which is slim and long, making it difficult to dispose a liquid crystal display on the top of the camera body.

### SUMMARY OF THE INVENTION

The present invention relates to a digital imaging apparatus with a plurality of displays that can display different content simultaneously. A display disposed on the top can be used for waist level photographing, and a display on the back can be used for eye level photographing. A variety of different modes is possible. Image content may be displayed on one of the displays while status information, such as photographing parameters or camera status, may be displayed on the other display. Different image content may be displayed on both displays simultaneously. For example, real-time video related to the photographing part of the camera may be displayed on one of the displays, while a recorded image may be displayed on the other display. Different recorded images may be displayed on the two displays simultaneously.

According to an embodiment of the invention, the display may be of different sizes. One display may have an aspect ratio of 4:3 and another may have an aspect ratio of 16:9. When operated in a wide mode, image content may be displayed on the 16:9 aspect ratio display; when operated in a normal mode, image content may be displayed on the 4:3 aspect ratio display.

According to an embodiment of the invention, a digital imaging apparatus may be provided with a display having an aspect ratio of 16:9. In one mode, image content may be displayed on the entire display in a wide format. In another mode, image content may be displayed on a central portion of the display in a 4:3 aspect ratio format. Informational content may be displayed on the portion of the display outside of the 4:3 aspect portion.

According to an embodiment of the invention, a digital imaging apparatus may be provided with at least two displays, where one display is disposed generally at the back of the apparatus and perpendicular to the optical axis, and the other display is disposed generally on the top of the apparatus and parallel to the optical axis.

### BRIEF DESCRIPTION OF THE DRAWINGS

The above and other features and advantages of the present invention will become more apparent from the following detailed description and the attached drawings in which:

FIG. 1 is a perspective view of a digital imaging apparatus according to an embodiment of the present invention;

FIG. 2 is a cross-sectional view of the digital imaging apparatus according to an embodiment of the present invention;

FIG. 3 is a block diagram of the digital imaging apparatus according to an embodiment of the present invention;

FIGS. 4A and 4B are plane views of example content on various displays the digital imaging apparatus according to an embodiment of the present invention;

FIG. 5 is a detailed block diagram of the digital imaging apparatus according to an embodiment of the present invention; and

FIG. 6 is a cross-sectional view of a digital imaging apparatus according to another embodiment of the present invention.

### DETAILED DESCRIPTION OF THE INVENTION

The present invention will now be described more fully with reference to the accompanying drawings.

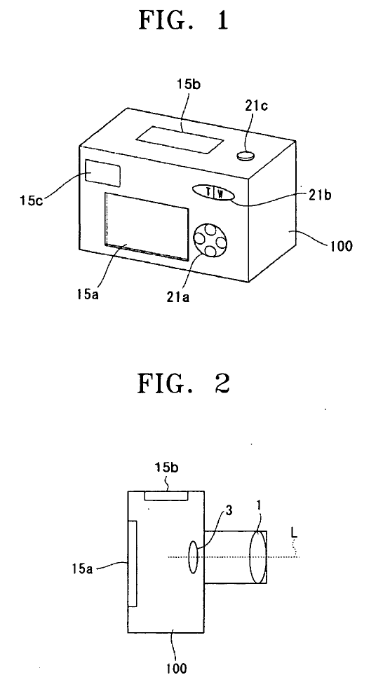

FIG. 1 is a perspective view of a digital imaging apparatus, such as a camera, obliquely from the rear according to an embodiment of the present invention. FIG. 2 is a cross-sectional view of the camera shown in FIG. 1.

Referring to FIGS. 1 and 2, the digital camera comprises a camera body 100, a zoom lens 1, a focus lens 3, a first display 15a, a second display 15b, a third display 15c, a cross key 21a, a zoom switch 21b, and a shutter switch 21c. The camera body 100 may be cube-shaped, or circular-shaped or other shapes.

The zoom lens 1 and the focus lens 3 form a photographing portion of the digital camera. An optical axis L of the zoom lens 1 and the focus lens 3 are parallel to each other as illustrated in FIG. 2, and generally perpendicular to the front and rear of the camera body 100.

The rear of the camera body 100 comprises the first display 15a, the third display 15c, the cross key 21a, and the zoom switch 21b. The top of the camera body 100 comprises the second display 15b and the shutter switch 21c.

The first display 15a, the second display 15b, and the third display 15c may be a liquid crystal display (LCD), an electro luminescence (EL) display, or a plasma display or other suitable display. According to an embodiment, the display screen of the first display 15a and the third display 15c may have a dimensional ratio of 4:3. According to an embodiment, the display screen of the second display 15b may have a dimensional ratio of 16:9.

Therefore, even if the camera body 100 is thin and has a slim and long top region, the second display 15b having a relatively wide screen can be arranged on the top region of the camera body 100. The wide screen of the second display 15b can be more easily divided into a plurality of screens.

The first display 15a may display a monitor image. That is, the first display 15a has a relatively large screen and displays an image photographed by photographing portion. A user can photograph the image by viewing the display screen of the first display at for example, between about 20 to 50 cm from the rear of the camera body.

The first display 15a can also display information relating to the camera or photographing status which can be superimposed on an image as an screen display (OSD). The information indicating the photographing status may include an iris status, a shutter speed, status of a variety of modes, brightness of a subject, battery consumption, etc. The status of a variety of modes may include the display mode of each display, a recording mode of the photographed image, etc. The recording mode may be a 5 megapixel mode, a 3 megapixel mode, a 2 megapixel mode, or other resolution, and a video recording mode. The display mode may be the mode of display contents of the first display 15a, the second display 15b, and the third display 15c. The display mode will be described later.

The third display 15c may function as an electronic view finder (EVF). That is, the third display 15c has the same function as an optical view finder and displays an image photographed by the photographing part. The user can photograph an image looking at the third display. The third display 15c the same size as the first display part 15a (a small image) and can display superimposed OSD information indicating the photographing status.

The second display 15b serves as the status display, displaying the photographing status and can display a monitor image. That is, the second display 15b simultaneously displays an image photographed and information indicating the photographing status. The second display 15b can display the photographed image with superimposed OSD information on the same display or the photographed image and the OSD information may be displayed on separate display regions.

Using the second display, the user can perform waist level photographing. To steady the camera to perform waist level photographing, the user can rest the camera body 100 on the user's stomach or can rest the user's elbow of their stomach while holding the camera. Also, the user can satisfactorily perform macro photographing through the second display part 15b.

The digital camera according to the current embodiment displays the monitor image on the first display part 15a, in order to perform the eye level photographing. Also, the digital camera can display the monitor image on the second display 15b, to perform the waist level photographing. Furthermore, the digital camera does not need a mechanism for changing the position of a display screen, thereby reducing mechanical cost and risk of malfunction.

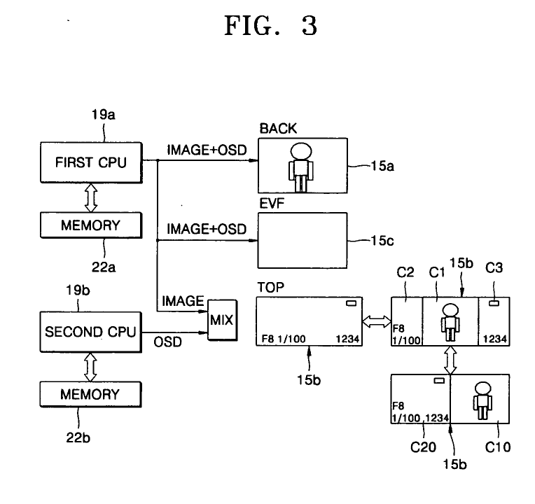

FIG. 3 is a block diagram of the digital camera according to an embodiment of the present invention. More specifically, FIG. 3 illustrates the display control and display mode features of the digital camera. Like reference numerals in FIGS. 1, 2, and 3 denote like elements. The digital camera comprises a first CPU 19a, a second CPU 19b, and two memories 22a and 22b, in addition to the elements illustrated in FIGS. 1 and 2.

The first CPU 19a controls the first display 15a, the second display 15b, and the third display 15c to display photographed images from the memory 22a. Each of the images displayed on the first display 15a, the second display 15b, and the third display 15c is controlled by the first CPU 19a. The first CPU 19a may select one, two or three of the first display 15a, the second display 15b or the third display 15c to display a photographed image.

The first CPU 19a may superimpose OSD information including an iris, a shutter speed, etc. on a photographed image displayed on the first display 15a and the third display 15c. Therefore, the first display 15a and the third display 15c can display the same image. When the third display 15c which is an Electronic View Finder (EVF) is not used, a user operates the cross key 21a and the first CPU 19a sets the first display 15a in a non-use state. In EVF photographing, a user operates the cross key 21a and the first CPU 19a sets the first display 15a in a non-use state.

The second CPU 19b may superimpose OSD information including the iris, the shutter speed, etc. on a photographed image displayed on the second display 15b. The second CPU 19b may also control the second display 15b to display a photographed image and OSD information on separate display regions. Even though the first CPU 19a and the second CPU 19b may output the same or different OSD information, the OSD information may be displayed on different display regions. Therefore, the two CPUs are used to display different OSD information on the first and third displays 15a and 15c, and the second display 15b.

When the first CPU 19a selects one of the first display 15a, the second display 15b, and the third display 15c to display a photographed image, the first CPU 19a may control the other non-selected displays to displays OSD information only. In this regard, other non-selected displays may serve as a status display. When one of the first display 15a, the second display 15b, and the third display 15c serves as the status display, the first CPU 19a may reduce a backlight operating current of the first display 15a, the second display 15b, or the third display 15c, thereby decreasing power consumption.

As illustrated in FIG. 3, the second CPU 19b may control the second display 15b to display OSD information on a separate region of the display. Also, the second CPU 19b may divide the second display 15b into three display regions lengthwise so that a center region c1 can display the photographed image, and a left region c2 and a right region c3 can display OSD information. In this regard, the aspect ratio of the photographed image and the center region c1 may be 4:3, such that the photographed image is displayed on one region of the display screen and the OSD information is clearly displayed on other regions.

The second CPU 19b may also divide the second display 15b into two display regions lengthwise so that a right region c10 can display a photographed image, and a left region c20 can display OSD information, and vice versa.

The display modes of the digital camera according to an embodiment will now be described with reference to FIGS. 1 to 3.

The digital camera includes a first mode where the first display 15a and the second display 15b simultaneously display the same photographed image, a second mode where one of the first display 15a and the second display 15b displays a photographed image, and a third mode where the first display 15a and the second display 15b simultaneously display different photographed images. The cross key 21a is a mechanism that may be used to select one of the three modes. That is, the first and second CPUs 19a and 19b perform the mode selected by the cross key 21a.

In the first mode, the first CPU 19a controls the first display 15a and the second display 15b to simultaneously display the same photographed image. The photographed image may be a video or a still image. In the first mode, when it is difficult for the user to perform the waist level photographing through the second display 15b due to a subject's unexpected movement, the user may perform eye level photographing through the first display 15a. Therefore, operation of the digital camera is flexible to handle a variety of photographing conditions and methods.

In the first mode, the first and second CPUs 19a and 19b control the first display 15a and the second display 15b to simultaneously display OSD information in addition to the same photographed image. As disclosed, according to an embodiment, the digital camera display a variety of information simultaneously.

In the third mode, the first and second CPUs 19a and 19b control one of the first and second display 15a and 15b to display the photographed image and display to display OSD information. In the non-selected particular, the first and second CPUs 19a and 19b control the first display 15a to display the photographed image when it is easier to see an image through the first display 15a and the second display 15b to display the camera status (OSD information) including the iris, the shutter speed, etc. According to an embodiment, the digital camera displays the photographed image and status information such that it is easy to see the image and check the status information.

In the third mode, the first and second CPUs 19a and 19b may control one of the first and second display 15a and 15b to display video and the other non-selected display to display a still image. For example, the first display 15a may display video obtained by a photographing operation, and the second display 15b may display a still image of the video at a certain time. Therefore, according to the embodiment, the digital camera can be used to check the photographing status of a subject via the still image displayed on one display, and a subject's movement or movement of a photographing direction via the video displayed on another display.

In the third mode, the first and second CPUs 19a and 19b may control one of the first and second display 15a and 15b to display video photographed by the photographing part and the other non-selected display to display an image recorded by the digital camera. For example, the first display 15a displays the video so the user can check the present photographing status, and simultaneously the second display 15b displays a past image (a still image or video) to check the past photographing status. Therefore, the digital camera according to an embodiment simultaneously displays the past and present photographing status.

When the digital camera starts to operate, the first and second CPUs 19a and 19b can control the first and second display 15a and 15b to display different images. In particular, the first display 15a may display an image obtained by the photographing part, and the second display 15b may display the OSD information, and vice versa.

The first and second CPUs 19a and 19b may also control the first and second displays 15a and 15b to display the same image. Various display modes may be selected by the cross key 21a. The digital camera of the current embodiment displays the first, second, and third modes after a predetermined time elapses from the start to operate of the digital camera. For this, a user operates a function member like the cross key 21a and the CPUs 19a, 19b, and 19c control the displays 15a, 15b and 15c according to that operation.

As can be seen, the digital camera of the invention can display various pieces of information in a variety of display modes using a plurality of displays after the digital camera is operated, thereby satisfactorily handling various shutter chances.

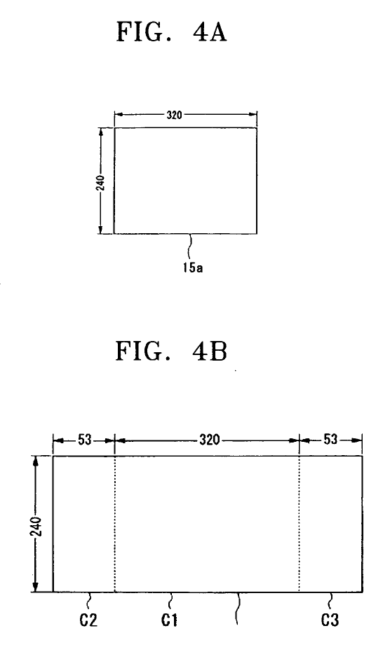

FIGS. 4A and 4B are plane views of example display screens for the various displays of the digital camera according to an embodiment. Like reference numerals in FIGS. 1, 2, 3, and 4 denote like elements.

More specifically, FIG. 4A illustrates a display screen for the first display 15a. The screen may be a conventional screen having an aspect ratio of 4:3. The screen may comprise 320 pixels across and 240 pixels down. FIG. 4B illustrates a display screen for the second display 15b. The screen may be a wide screen having an aspect ratio of 16:9. The screen may 426 pixels across and 240 pixels down.

The display screen for by the second display 15b may be divided into a center display region c1, a left display region c2, and a right display region c3. The center display region c1 is located in the center of the screen and may be formed of 320 pixels across and 240 pixels down. The left display region c2 is located on the left of the screen and may be formed of 53 pixels across and 240 pixels down. The right display region c3 is located on the right of the screen and may be formed of 53 pixels across and 240 pixels down.

The digital camera may operate in a normal mode in which a photographed image having the aspect ratio of 4:3 is displayed, and a wide mode in which a photographed image having the aspect ratio of 16:9 is displayed. The two modes are selected by operating the cross key 21a. When the normal mode is selected when a user operates the cross key 21a, the first CPU 19a may display an image in the normal mode (4:3 aspect) on the first display 15a. When the wide mode is selected when a user operates using the cross key 21a, the first CPU 19a may display an image in the wide mode (16:9 aspect) on the second display 15b.

Therefore, according the digital camera may display an image in the normal mode on the first display 15a having the aspect ratio of 4:3; or may display an image in a wide mode, on the second display 15b having the aspect ratio of 16:9.

When the normal mode is selected using the cross key 21a, the first CPU 19a controls the second display 15b to display the image in the normal mode on the center display region c1 and the OSD information on the left and right display regions c2 and c3. Therefore, in the normal mode, an image having the aspect ratio of 4:3 can be displayed on the center display region c1 of the second display 15b having the aspect ratio of 16:9, and character information can be displayed on the left and right display regions c2 and c3. Therefore, according to such an embodiment, the digital camera can display and without being partially covered by the character information.

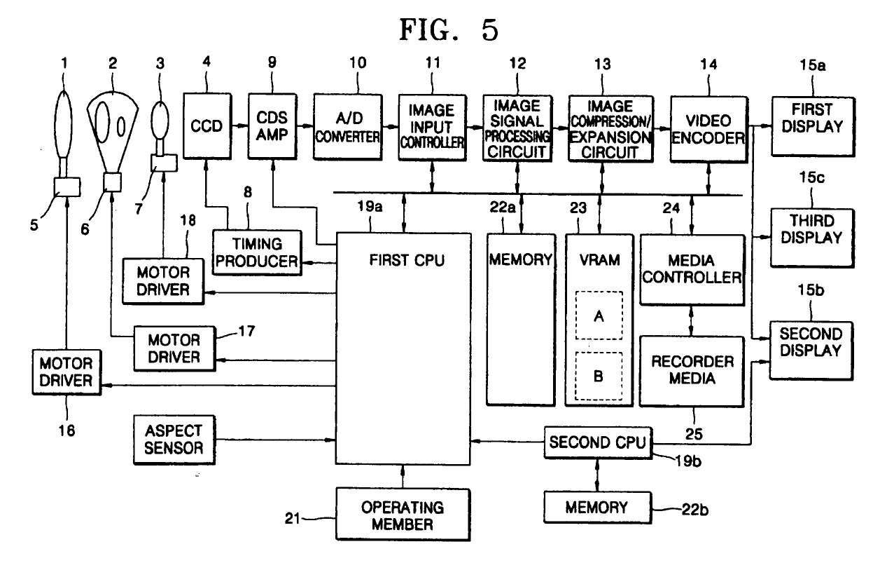

FIG. 5 is a detailed block diagram of the digital camera according to an embodiment of the present invention. Like reference numerals in FIGS. 1, 2, 3, 4, and 5 denote like elements.

Referring to FIG. 5, the digital camera of the current embodiment comprises the zoom lens 1, an iris 2, the focus lens 3, a charge-coupled device (CCD) 4, a zoom motor 5, an iris motor 6, a focus motor 7, a timing producer 8, and a correlated double sampling (CDS) and automatic gain control (AGC) circuit 9. The zoom lens 1, the iris 2, the focus lens 3, and the CCD 4 are elements of a photographing part for photographing a subject. The iris motor 6 comprises an iris variant unit that varies an opening of the iris 2. The timing producer 8 comprises a shutter speed variant unit that varies the shutter speed. The CDS and AGC circuit 9 forms a gain variant unit that varies the amplitude of the output of the CCD 4. The iris motor 6, the timing producer 8, and the CDS and AGC circuit 9 are elements of an exposure variant part that varies the exposure of the photographing part.

The zoom lens 1 is moved by the zoom motor 5. The iris motor 6 controls the opening of the iris 2. The focus lens 3 is controlled by the focus motor 7. Light from a subject is received through the zoom lens 1, the iris 2, and is focused by the focus lens 3 on a light receiving surface of the CCD 4.

The CCD 4 photo-converts the subject light formed on the light receiving surface. The CCD 4 may be a complementary metal oxide semiconductor (CMOS) device or other digital image sensor. A color filter is arranged on the whole surface of the CCD 4. The color filter may use three primary colors, red R, green G, and blue B, or use three complementary colors, cyan Cy, magenta Mg, and yellow Ye. The CCD 4 is operated by a timing signal produced by the timing producer 8.

According to an embodiment, the digital camera comprises an A/D converter 10, an image input controller 11, an image signal processing circuit 12, an image compression/expansion circuit 13, a video encoder 14, a first display 15a, a second display 15b, a third display 15c, motor drivers 16, 17, and 18, a first CPU 19a, a second CPU 19b, an operating member 21, memories 22a and 22b, a video RAM (VRAM) 23, a media controller 24, and recording media 25. The operating member 21 includes a power switch, a mode conversion dial, etc. in addition to the cross key 21a, the zoom switch 21b, and the shutter switch 21c.

The first CPU 19a may control general operation of the digital camera according to an embodiment. The first CPU 19a controls an automatic exposure (AE) and an automatic focus (AF) based on setting conditions of the operating member 21 and outputs of the CCD 4.

The operating member 21 provides an input signal to the first CPU 19a. The first CPU 19a outputs a zoom operating signal for moving the zoom lens 1, a focus operating signal for moving the focus lens 3, an iris operating signal for opening/closing the iris 2, and a gain control signal for controlling gain of the CDS and AGC circuit 9.

An output signal of the CCD 4 is supplied to the A/D converter 10 from the CDS and AGC circuit 9. The A/D converter 10 digitizes the image signal. An output signal of the A/D converter 10 supplied to the image input controller 11 and stored in the memory 22a.

The output signal of the CCD 4 is digitized by the A/D converter 10 from the CDS and AGC circuit 9 and then supplied to the image signal processing circuit 12. The image signal processing circuit 12 performs image processing such as gamma correction, edge emphasis, white balance, etc. The video encoder 14 produces a component color video signal, which is supplied to the VRAM 23. The color video signal is supplied to each of the first, second, and third displays 15a, 15b, and 15c, or to one or two of them to display a monitor image which is being photographed.

Also, the first CPU 19a controls the image signal processing circuit 12 to superimpose OSD information including the iris, the shutter speed, etc. on the photographed image, such that the superimposed image can be displayed on the first and third display part 15a and 15c. The second CPU 19b controls the second displays 15b to display OSD information and the photographed image.

The image signal corresponding to a screen stored in the memory 22a is processed in the image signal processing circuit 12 and is provided to the image compression/expansion circuit 13. The image compression/expansion circuit 13 compression-encodes image data. The image data, not necessarily restricted thereto, may be compressed according to Joint Photographic Experts Group (JPEG) standards for image compression based on a discrete cosine transform (DCT).

The compression-encoded image signal is provided to the recording media 25 via the media controller 24 and is recorded on the recording media 25. The recording media 25 may be an attachable/detachable card type memory using a flash memory. The recording media 25 may be comprised of a nonvolatile memory, a magnetic tape, a magnetic disk, an optical disk embedded in the digital camera.

An image file of the recording media 25 is open when it is reproduced and the image data is read. The image data read from the recording media 25 is supplied to the image compression/expansion circuit 13. The image compression/expansion circuit 13 expands the image signal. An output of the image compression/expansion circuit 13 is supplied to the video encoder 14. An output signal of the video encoder 14 is supplied to one of, two of, or all of, the first, second, and third displays 15a, 15b, and 15c, to display a reproduced image.

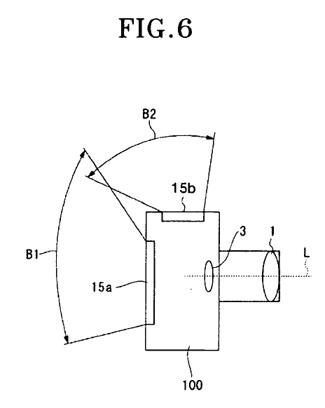

FIG. 6 is a cross-sectional view of a digital camera according to another embodiment of the present invention. Like reference numerals in FIGS. 1, 2, 3, 4, 5, and 6 denote like elements. The digital camera illustrated in FIG. 6 has a first display 15a and a second display 15b which have a modified view angle from a conventional display.

As is known be one of skill in the art, conventional display panels have a limited viewing angle. In other words, when a conventional display is viewed directly, the quality of the image is the best, with all of the detail clearly visible and in the appropriate colors. However, when viewed from an angle toward the side, the image quality may be degraded or appear black, or the colors are modified from the true colors. This phenomenon is characteristic of many different display technologies, especially LCD displays.

A first display 15a is disposed at the rear of the camera body 100 generally perpendicular to the optical axis L of the zoom lens 1 and the focus lens 3. A second display 15b is arranged on the top of the camera body 100 generally parallel to the optical axis L.

In accordance with this embodiment of the invention, the first display 15a is not a conventional display, but a display that has a modified view angle B1 that preferably extends much higher and toward the top of the camera than a conventional display so that the display is more readily viewable if the camera is held at a wait-level position. Similarly, display 15b, which is disposed on the top of the camera, also has a modified view angle B2 that preferably extends much lower and toward the back of the camera so that the display 15b is more readily viewable if the camera is held in a position between waist-level and eye-level. As illustrated in FIG. 6, there is an overlap of the view angle B1 for the display 15a disposed on the back of the camera and the view angle B2 for the display 15b disposed on the top of the camera. In addition, the combination of the view angle B1 and the view angle B2 provide a combined viewing angle that extends beyond 90 degrees. In this regard, using the combination of the two displays 15a and 15b, a user can enjoy a continuous and extremely large combined viewing angle, extending from the forward-most angle of B2 and through to the lower-most angle of B1. Thus, a user can readily, easily and continuously view display information extending from eye-level photographing to waist-level photographing, and any position between.

The present invention is not restricted to a digital camera but can readily be applied to a video camera, a film camera, or other imaging device.

A plurality of displays can display the same or different contents, thereby satisfactorily handling various photographing status and methods.

The two displays accommodate photographing at both the eye level and the waist level. Therefore, the present invention can display photographing status and a photographed image on the top of the camera body. The present invention prevents hand tremble caused by the waist level photographing, performs macro photographing, and the eye level photographing. The present invention does not require mechanical movement of the displays, thereby reducing the risk of mechanical malfunction.

Each of the plurality of displays can display the same or different contents when the digital camera is operated.

A view angle of each of the plurality of displays is established according to the location of each of the plurality of displays of the digital camera.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A digital imaging apparatus comprising:
a photographing part for photographing an image;
at least two displays;
a controller for controlling the content displayed on the at least two displays;
a mode selection member for selecting one of at least three display modes, said display modes comprising a first mode where substantially the same content is displayed on the first display and the second display, a second display mode where content is displayed on one of the first display and the second display, and a third display mode where different content is displayed on the first display and the second display.

2. The digital imaging apparatus of claim 1 where substantially the same image content of a photographed image is displayed on the first display and the second display in the first display mode.

3. The digital imaging apparatus of claim 1 where substantially the same content other than a photographed image is displayed on the first display and the second display in the first display mode.

4. The digital imaging apparatus of claim 1 where image content of a photographed image is displayed on one of the first display and the second display and content other than a photographed image is displayed on the other of the first display and the second display in the third display mode.

5. The digital imaging apparatus of claim 1 where video content is displayed on one of the first display and the second display and still image content is displayed on the other of the first display and the second display in the third display mode.

6. The digital imaging apparatus of claim 1 further comprising storage media for recording at least image and video content photographed by the photographing part and where recorded video content is displayed on one of the first display and the second display and recorded image content is displayed on the other of the first display and the second display in the third display mode.

7. The digital imaging apparatus of claim 1 where video content relating to real-time video information from the photographing part is displayed on one of the first display and the second display and still image content is displayed on the other of the first display and the second display in the third display mode.

8. The digital imaging apparatus of claim 1 further comprising storage media for recording at least image content photographed by the photographing part and where video content relating to real-time video information from the photographing part is displayed on one of the first display and the second display and still image recorded image content is displayed on the other of the first display and the second display in the third display mode.

9. A digital imaging apparatus comprising:
a photographing part for photographing an image;
at least one display;
a mode selector for selecting between at least two display modes, said display modes comprising a first display mode where image content is displayed on substantially the entire display, and a second display mode where image content is displayed on an image portion of the display which is less than substantially the entire display and informational content is displayed on the remaining portion of the display.

10. The digital imaging apparatus of claim 9 where the informational content is content from the group consisting of image informational content, video informational content, camera status informational content and the photographing part informational content.

11. The digital imaging apparatus of claim 9 where the informational content is of the type from the group consisting of characters, numerals and icons.

12. The digital imaging apparatus of claim 9 where the display is substantially rectangular and in the second mode, the display is subdivided into a left region, a central region, and a right region, and the image portion is the central region and the left and right regions display informational content.

13. The digital imaging apparatus of claim 12 where the display has an aspect ratio of substantially 16:9 and the central region has an aspect ratio of substantially 4:3.

14. The digital imaging apparatus of claim 9 where informational content is superimposed on the image content in the first display mode.

15. A digital imaging apparatus comprising:
a photographing part for photographing an image;
at least a first display and a second display where a photographed image may be displayed on either or both of the first display and the second display, the plane of the first display and the plane of the second display are substantially perpendicular to each other.

16. The digital imaging apparatus of claim 15 where the first display is substantially perpendicular to the optical axis of the photographing part and the second display is substantially parallel to the optical axis of the photographing part.

17. The digital imaging apparatus of claim 15 where the first display has an aspect ratio of substantially 16:9 and the second display has an aspect ratio of substantially 4:3.

18. The digital imaging apparatus of claim 15 where the first display is disposed on the back of the digital imaging apparatus and the second display is disposed on the top of the digital imaging apparatus.

19. The digital imaging apparatus of claim 18 where image content is displayed on the first display during eye-level photographing and image content is displayed on the second display during waist-level photographing.

20. The digital imaging apparatus of claim 19 where the image content is video content relating to real-time video information from the photographing part.

21. A digital imaging apparatus comprising:
a photographing part for photographing an image;
at least a first display having an aspect ratio of substantially 4:3 and a second display having an aspect ratio of substantially 16:9;
a mode selector for selecting between at least a normal mode where image content is displayed on the first display and a wide mode where image content is displayed on the second display.

22. The digital imaging apparatus of claim 21 where the mode selector may select an additional mode where image content is display in substantially a 4:3 aspect ratio on a substantially 4:3 aspect ratio portion of the second display.

23. The digital imaging apparatus of claim 22 where informational content is displayed on the portion of the second display outside of the substantially 4:3 aspect ratio portion of the second display.

24. The digital imaging apparatus of claim 22 where the substantially 4:3 aspect ratio portion of the second display is centrally located within the second display.

25. A digital imaging device comprising:
a photographing part for photographing and image;
at least a first display disposed on the back of the digital imaging device and having an upper viewing angle that extends upwardly at an angle greater than a conventional display, and a second display disposed on the top of the digital imaging device and having a rearward viewing angle that extends rearwardly at an angle greater than a conventional display.

26. The digital imaging device of claim 25 where the upper viewing angle of the first display and the rearward viewing angle of the second display overlap.

27. The digital imaging device of claim 25 where combination of the first display and the second display provide a combined viewing angle that extends greater than 90 degrees.

28. A method of operating a digital imaging device having a photographing part for photographing an image, and at least a first display and a second display for displaying an image, the method comprising the steps:
selecting one of at least three different display modes and controlling the two displays based upon said selection,
in the first display mode, displaying substantially the same content on the first display and the second display,
in the second display mode, displaying content on one of the first display and the second display, and
in the third display mode, displaying different content on the first display and the second display.

29. The method according to claim 28 where, in the third display mode, video content is displayed on one of the first display and the second display and still image content is displayed on the other of the first display and the second display.

30. The method according to claim 28 where, in the third display mode, real-time video information from the photographing part is displayed on one of the first display and the second display and still image content is displayed on the other of the first display and the second display.

31. A method of operating a digital imaging device having a photographing part of photographing an image and at least one display, the method comprising the steps:
in a first mode, displaying image content on substantially the entire display,
in a second mode, displaying image content on an image portion of the display which is less than substantially the entire display and displaying informational content on the remaining portion of the display.

32. The method according to claim 31 where the informational content is content from the group consisting of image informational content, video informational content, camera status informational content and the photographing part information content.

33. The method according to claim 31 where the informational content is of the type from the group consisting of characters, numerals and icons.

34. The method according to claim 31 where the display is substantially rectangular and further comprising the step of, in the second mode, subdividing the display into a left region, a central region, and a right region, and the image portion is the central region.

35. The method according to claim 31 further comprising the step of, in the first display mode, superimposing informational content on the image content.
